(19) United States
(12) Patent Application Publication
(10) Pub. No.: US 2024/0386443 A1
(43) Pub. Date: Nov. 21, 2024

(54) EXPORT LICENSE AGENCY SERVICE SYSTEM AND METHOD AND COMPUTER PROGRAM FOR THE SAME

(71) Applicant: AUTOWINI INC., Seoul (KR)

(72) Inventor: Ji Young HAN, Seongnam-si (KR)

(21) Appl. No.: 18/635,062

(22) Filed: Apr. 15, 2024

(30) Foreign Application Priority Data
May 16, 2023 (KR) 10-2023-0063359

(51) Int. Cl. G06Q 30/018

(52) U.S. Cl. CPC G06Q 30/018

(57) ABSTRACT

A license agency service system may include: a service module configured to receive license agency service application information of a seller and product information of one or more products that the seller will export from one or more devices related to the seller; and a license management module configured to transmit license application information generated based on the license agency service application information and the product information to a user device of one or more agents, and receive license information issued from a customs management authority, corresponding to the license application information, from the agent or the customs management authority. Herein, the service module is further configured to provide the license information to the one or more devices.

### CROSS-REFERENCE TO RELATED APPLICATION

This application claims priority to Korean Patent Application No. 10-2023-0063359, filed on May 16, 2023, and all the benefits accruing therefrom under 35 U.S.C. § 119, the contents of which in its entirety are herein incorporated by reference.

### BACKGROUND

### 1. Field

Embodiments relate to a license agency service system and method and a computer program therefor. More particularly, embodiments relate to technology that performs a procedure for making an export declaration and obtaining a license (an export permit) to/from a customs management authority (a customs administration, etc.) on behalf of a seller who will sell internationally, thereby reducing the time taken by the seller to prepare the required documents for license application and the time spent on processing paperwork between the seller and a customs agent, contributing to convenience.

### 2. Description of the Related Art

Sellers who intend to sell internationally are required to report exporting products and export transactions to custom management authorities such as customs administrations and to obtain export declaration certificates, i.e., export permits.

The export permit is used to certify legitimacy of the product and transaction description, and generally, the export permit includes (i) personal information such as company name/name, address and contact number of the declarant, buyer, export agent, etc. (ii) detailed information such as model/size, description, quantity of the product, (iii) export terms information such as the price and quantity of the product, currency, payment terms, shipping terms, etc., (iv) tariff and tax information, (v) declaration information such as export declaration date, export declaration number, etc. The license as used herein is intended to refer to an export permit for exporting to another country or its issuance procedure.

To get the export license, communication with the customs management authority such as the customs administration, compliance with local legal regulations and expert knowledge of tariff and tax are needed, and accordingly, sellers generally get licenses through customs agents that specialize in the field of export, import and international trade. However, the conventional licensing process is performed through off-line communication between individual sellers and customs agents, and there is no platform based on information and communication technology for simple, easy and convenient export license application.

For example, Korean Patent No. 10-2401652 discloses an export procedure combined with information and communication technology, wherein a manager terminal of an export agent server connects to a customs administration server to transmit a used vehicle export declaration and receive an export permit, transmits a value-added tax (VAT) refund declaration and the export permit to a tax authority server, receives a VAT refund approval notification and transmits the same to a seller terminal.

However, the technology disclosed in Korean Patent No. 10-2401652 aims at owing the VAT on the export of the used vehicle to the seller and is not intended to make an export declaration and get an export permit, and the manager has to personally input information associated with the seller (or the export agent) or the product to get an export permit.

### SUMMARY

According to an aspect of the present disclosure, a license agency service system and method are provided for performing a procedure for making an export declaration and obtaining a license (an export permit) to/from a customs management authority (a customs administration, etc.) on behalf of a seller who will sell internationally, thereby reducing the time taken by the seller to prepare the required documents for license application and the time spent on processing paperwork between the seller and a customs agent and simplifying the export procedure and a computer program therefor.

The license agency service system according to an embodiment comprises: a service module configured to receive license agency service application information of a seller and product information of one or more products that the seller will export from one or more devices related to the seller; and a license management module configured to transmit license application information generated based on the license agency service application information and the product information to a user device of one or more agents, and receive license information issued from a customs management authority, corresponding to the license application information, from the agent or the customs management authority. Herein, the service module is further configured to provide the license information to the one or more devices.

In an embodiment, the service module is further configured to connect to a sales management server for trade in the one or more products to receive at least one of the license agency service application information or the product information from the sales management server via communication.

In an embodiment, the license agency service application information includes deregistration type information of the product. Further, the service module includes an application information verification unit further configured to verify the license agency service application information based on a preset required information item corresponding to the deregistration type information.

In an embodiment, the license agency service application information includes country information to which the product is to be exported. Further, the service module includes an application information verification unit configured to determine whether license translation is required based on the country information, and transmit translated license application information to the license management module in response to the determination that the license translation is required. Furthermore, the license management module is further configured to, in response to the translated license application information being received, transmit the translated license application information to the agent and receive translated license information from the agent or the customs management authority.

In an embodiment, the service module includes a duplicate check unit configured to transmit identification information corresponding to the license agency service application information or the product information to the license management module and verify whether license issuance for the product information is a duplicate application.

In an embodiment, the license agency service application information includes shipment type information for the export of the product. Further, the license management module includes an information extraction unit configured to selectively gather the information received at the service module based on the shipment type information to generate the license application information.

In an embodiment, the license management module includes a license verification unit configured to verify whether at least one of a shipment type, a product name or a name of the seller of the license information received from the agent or the customs management authority is consistent with the license application information.

The license agency service method according to an embodiment comprises: receiving, by a license agency service system, license agency service application information of a seller and product information of one or more products that the seller will export from one or more devices related to the seller; transmitting, by the license agency service system, license application information generated based on the license agency service application information and the product information to a user device of one or more agents; receiving, by the license agency service system, license information issued from a customs management authority, corresponding to the license application information, from the agent or the customs management authority; and providing, by the license agency service system, the license information to the one or more devices.

In an embodiment, the license agency service application information includes deregistration type information of the product. Herein, the license agency service method further comprises: before the transmitting to the user device of the agent, verifying, by the license agency service system, the license agency service application information based on a preset required information item corresponding to the deregistration type information.

In an embodiment, the license agency service application information includes country information to which the product is to be exported. Herein, the license agency service method further comprises: determining, by the license agency service system, whether to apply for a translated license based on the country information; transmitting, by the license agency service system, translated license application information based on the license information issued corresponding to the product to the agent in response to the determination that license translation is required; and receiving, by the license agency service system, translated license information from the agent or the customs management authority.

In an embodiment, the license agency service method further comprises: before the transmitting to the user device of the agent, verifying, by the license agency service system, whether license issuance for the product information is a duplicate application using identification information corresponding to the license agency service application information or the product information.

In an embodiment, the license agency service application information includes shipment type information for the export of the product. Herein, the transmitting to the user device of the agent comprises selectively gathering, by the license agency service system, the information received at the license agency service system based on the shipment type information to generate the license application information.

In an embodiment, the license agency service method further comprises: before the providing of the license information to the one or more devices, verifying, by the license agency service system, whether at least one of a shipment type, a product name or a name of the seller of the license information received from the agent or the customs management authority is consistent with the license application information.

The computer program according to an embodiment is stored in a computer-readable recording medium to perform the license agency service method according to any one of the afore-mentioned embodiments in combination with hardware.

The computing device according to an embodiment comprises: a memory in which executable instructions are stored; a communication module configured to communicate with an external system; and a processor connected to the memory and the communication module to enable communication therebetween.

The processor is configured to execute the instructions to: receive license agency service application information of a seller and product information of one or more products that the seller will export from one or more devices related to the seller, transmit license application information generated based on the license agency service application information and the product information to a user device of one or more agents, receive license information issued from a customs management authority, corresponding to the license application information, from the agent or the customs management authority, and provide the license information to the one or more devices.

Using the license agency service system and method according to an aspect of the present disclosure, when the seller applies for an export license agency service to the sales management server for the product sales of the seller, the license agency service system receives the required information for export declaration from the sales management server and automatically makes an export declaration, thereby reducing the time required by the seller to prepare the required documents for license application and the time spent on paperwork between the seller and the customs agent for the license agency service and simplifying the export process.

Using the license agency service system and method according to an aspect of the present disclosure, the system may automatically check the required information for license application such as seller information, product information, etc. and make an accurate export declaration, and the task details may be used as basic data for charging the fee of the customs agent.

Further, using the license agency service system and method according to an aspect of the present disclosure, as the license declaration process is performed during the export preparation, there is no need for an additional operation such as license cancellation or alteration in the event that the date of loading is extended or the shipment type is changed, thereby reducing the effort and cost compared to the conventional export licensing process.

### BRIEF DESCRIPTION OF THE DRAWINGS

FIG. 1 is a schematic block diagram of a license agency service system according to an embodiment.

FIG. 2 is a schematic block diagram of hardware of a license agency service system according to an embodiment.

FIG. 3 is a schematic block diagram showing a service module and an authentication module of a license agency service system according to an embodiment.

FIG. 4 is a flowchart showing each step of a license agency service method according to an embodiment.

FIG. 5 is a flowchart showing each step of a license agency service method in the event that license information verification fails according to an embodiment.

FIG. 6 is a flowchart showing each step of a license agency service method according to another embodiment.

### DETAILED DESCRIPTION

Hereinafter, embodiments of the present disclosure will be described in detail with reference to the accompanying drawings.

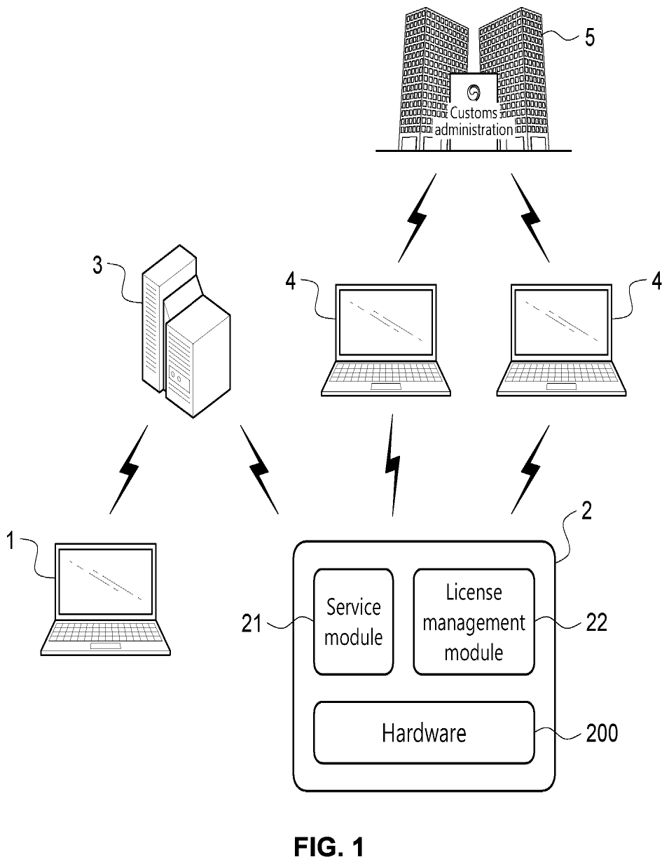

FIG. 1 is a schematic block diagram of a license agency service system according to an embodiment.

Referring to FIG. 1, the license agency service system 2 according to this embodiment transmits license application information needed to obtain an export license (i.e., an export permit) to a user device 4 of an agent such as a customs agent based on license agency service application information and product information received from one or more devices 1, 3 related to a seller, and provides the seller with license information issued from a customs management authority such as a customs administration server 5 through task accomplished by the customs agent, thereby contributing to convenience of work for the seller and the customs agent.

In an embodiment, the license agency service system 2 may be configured to receive information from the seller or provide information to the seller through the sales management server 3 for the trade in the seller's product bound for export. For example, the sales management server 3 may be a server that provides an electronic commerce service by registering product information of, for example, used vehicles that one or more sellers will sell internationally and allowing overseas buyers to see the product information and buy desired products.

However, this is provided by way of illustration, and in another embodiment, the license agency service system 2 may be configured to directly communicate with the user device 1 of the seller. In this case, the sales management server 3 shown in FIG. 1 may be omitted.

To receive the license agency service application information of the seller and provide the license information and provide the license application information to the customs agent and receive the license information, in an embodiment, the license agency service system 2 may be embodied in the form of a server that is accessible using a computing device. For example, the license agency service system 2 may be an application service server which enables the operation of an application (or an app) that runs on the user devices 1, 4 of the seller or the customs agent or any other computing device. Alternatively, the license agency service system 2 may be a web server which provides a web page that is accessible by a web browser.

The seller and the customs agent may connect to the license agency service system 2 via a wired and/or wireless network using the user devices 1, 4 such as a mobile communication terminal including a smartphone, or a computing device including a personal computer, a laptop computer, personal digital assistant (PDA), a tablet, a set-top box for Internet Protocol Television (IPTV), an Artificial Intelligence (AI) speaker or a network server. Additionally, the seller may transmit and receive information to/from the license agency service system 2 through the sales management server 3.

To this end, the license agency service system 2 may be configured to transmit and receive information to/from the user device 1 of the seller, the user device 4 of the agent that applies for a license on behalf of the seller such as the customs agent, and/or the sales management server 3 via the wired and/or wireless network. The communication method via the wired and/or wireless network may include any communication method for networking between objects, and is not limited to wired communication, wireless communication, 3G, 4G or any other method.

For example, the wired and/or wireless network refers to a communication network by at least one communication method selected from the group consisting of Local Area Network (LAN), Metropolitan Area Network (MAN), Global System for Mobile Network (GSM), Enhanced Data GSM Environment (EDGE), High Speed Downlink Packet Access (HSDPA), Wideband Code Division Multiple Access (W-CDMA), Code Division Multiple Access (CDMA), Time Division Multiple Access (TDMA), Bluetooth, Zigbee, Wi-Fi, Voice over Internet Protocol (VOIP), LTE Advanced, IEEE802.16m, WirelessMAN-Advanced, HSPA+, 3GPP Long Term Evolution (LTE), Mobile WiMAX (IEEE 802.16e), UMB (formerly EV-DO Rev. C), Flash-OFDM, iBurst and MBWA (IEEE 802.20) systems, HIPERMAN, Beam-Division Multiple Access (BDMA), World Interoperability for Microwave Access (Wi-MAX) and ultrasonic communication, but is not limited thereto.

In another embodiment, the license agency service system 2 itself may be a generic system including the sales management server 3. In this embodiment, a service module 21 and a license management module 22 of the license agency service system 2 may make up a licensing server, and the sales management server 3 may be connected to the licensing server to enable communication between them or may be physically incorporated into the licensing server. For example, the licensing server and the sales management server 3 may be respective servers connected to each other to enable communication between but may work as a single license agency service system that is managed by the same administrator.

In an embodiment, the license agency service system 2 may include the service module 21 and the license management module 22. Additionally, each module 21, 22 may be embodied using hardware 200 of the license agency service system 2.

The devices described herein may have aspects of entirely hardware, or partly hardware and partly software. For example, the license agency service system 2 according to embodiments and each of a system, a device and a server that communicate with the license agency service system 2 and each unit included therein may refer collectively to a device for transmitting and receiving data of a particular format and content by an electronic communication method and its related software. The term “unit”, “module”, “server”, “system”, “platform”, “device” or “terminal” as used herein is intended to refer to a combination of hardware and software run by the corresponding hardware. For example, here, the hardware may be a data processing device including a central processing unit (CPU) or other processor. Additionally, the software run by the hardware may refer to a process being executed, an object, an executable, a thread of execution and a program.

In the specification, each module 21, 22 or unit of the license agency service system 2 is not necessarily intended to refer to separate components that are physically distinguished from one another. That is, although FIG. 1 shows each module 21, 22 of the license agency service system 2 as separate blocks that are physically distinguished from one another, this represents the functional separation of the license agency service system 2 by the operation performed thereby. According to embodiments, all or some of the above-described modules may be integrated into a same device, or may be implemented as separate devices such that at least one module is physically separated from another module. For example, each module of the license agency service system 2 may be components connected to one another to enable communication under a distributed computing environment.

The service module 21 may receive the license agency service application information and the product information of one or more products that the seller will export from one or more devices related to the seller. When the seller applies for a license agency service personally to the license agency service system 2, one or more devices related to the seller may be the user device 1 of the seller. Alternatively, when the seller registers his/her product in the sales management server 3 to sell the product and applies for a license agency service to the sales management server 3 at the same time, one or more devices related to the seller may be the sales management server 3.

The license management module 22 may generate the license application information that will be submitted to the customs administration based on the license agency service application information and the product information of the seller, and transmit the same to the user device 4 of one or more agents such as the customs agent that will apply for a license on behalf of the seller. In the following description, the agent is described as the customs agent, but is not limited thereto, and in embodiments of the present disclosure, the agent refers to an entity such as an individual, a company, a businessman, etc. that makes an export declaration on behalf of the seller.

When the customs agent receives the license information from the customs management authority such as the customs administration server 5, the license management module 22 may receive the license information from the user device 4 of the customs agent and/or the customs administration server 5 and transmit the same to one or more devices related to the seller, for example, the user device 1 of the seller and/or the sales management server 3.

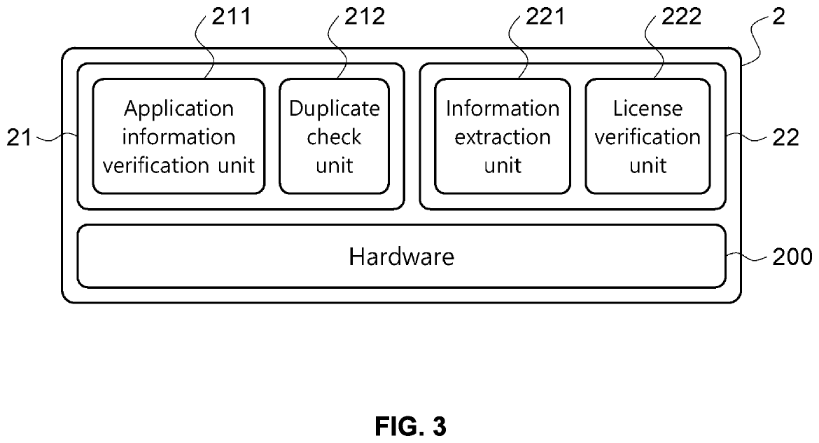

The service module 21 and the license management module 22 will be described in detail with reference to FIG. 3 below.

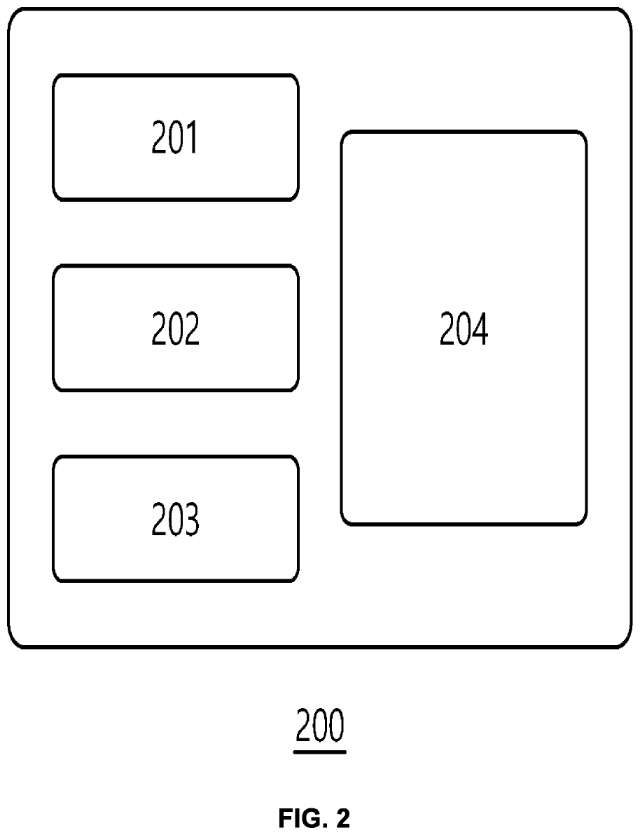

FIG. 2 is a schematic block diagram of the hardware of the license agency service system according to an embodiment.

Referring to FIG. 2, the license agency service system according to embodiments may be embodied in the form of a computing device including the hardware 200, and may include a memory 201, a processor 202, a communication unit 203 and an input/output unit 204.

The memory 201 may be a non-transitory computer-readable recording medium, and may include a permanent mass storage device such as random access memory (RAM), read only memory (ROM), disk drive, solid state drive (SSD), flash memory, etc. Here, the permanent mass storage device such as ROM, SSD, flash memory, disk drive, etc. may be a permanent storage device that is different from the memory 201 and may be included in the above-described device or server.

Additionally, the memory 201 may store an operating system and at least one program code (for example, code for a security module or an application installed to provide a particular service, etc.). These software components may be loaded from a computer-readable recording medium that is different from the memory 201. The computer-readable recording medium may include computer-readable recording media such as floppy drive, disk, tape, DVD/CD-ROM drive, memory card, etc.

In another embodiment, the software components may be loaded into the memory 201 through the communication unit 203, not the computer-readable recording medium. For example, at least one program may be loaded into the memory 201 based on a computer program installed by files provided via the network by developers or a file distribution system (for example, an application store service server) that distributes application installer files.

The processor 202 may be configured to execute the instructions of the computer program by performing the basic operation, i.e., the arithmetic, logic and input/output operations. The instructions may be provided to the processor 202 by the memory 201 or the communication unit 203. For example, the processor 202 may be configured to execute the instructions received according to the program code stored in the recording device such as the memory 201.

The communication unit 203 may provide a function for the communication of the license agency service system with the user devices 1, 4 and/or the sales management server 3 via the network. Additionally, the communication unit 203 may provide a function for the communication of the license agency service system with one or more other devices via the wired and/or wireless network. That is, the function of the communication unit 203 is controlled by the processor 202 that references the memory 201, thereby enabling each functional module described above with reference to FIG. 1.

The input/output unit 204 may be a device for interfacing with an external input/output device (not shown). For example, the external input device may include a keyboard, a mouse, a microphone, a camera, etc. and the external output device may include a display, a speaker, a haptic feedback device, etc. In another example, the input/output unit 204 may be a device for interfacing with a device having an integrated function for input and output such as a touchscreen.

Additionally, in other embodiments, the license agency service system may include a larger number of hardware components than the components shown in FIG. 2 according to the nature of device applied. For example, when the license agency service system is applied to the terminal device of the user, the license agency service system may include at least some of the above-described input/output devices or may further include other components such as a transceiver, a Global Positioning System (GPS) module, a camera, different types of sensors, a database, etc. In a more specific example, when the terminal device is a smartphone, the license agency service system may further include an acceleration sensor or a gyro sensor, a camera module, different types of physical buttons, buttons using touch panels, an input/output port, a vibration tool for vibration, etc. commonly included in the smartphone.

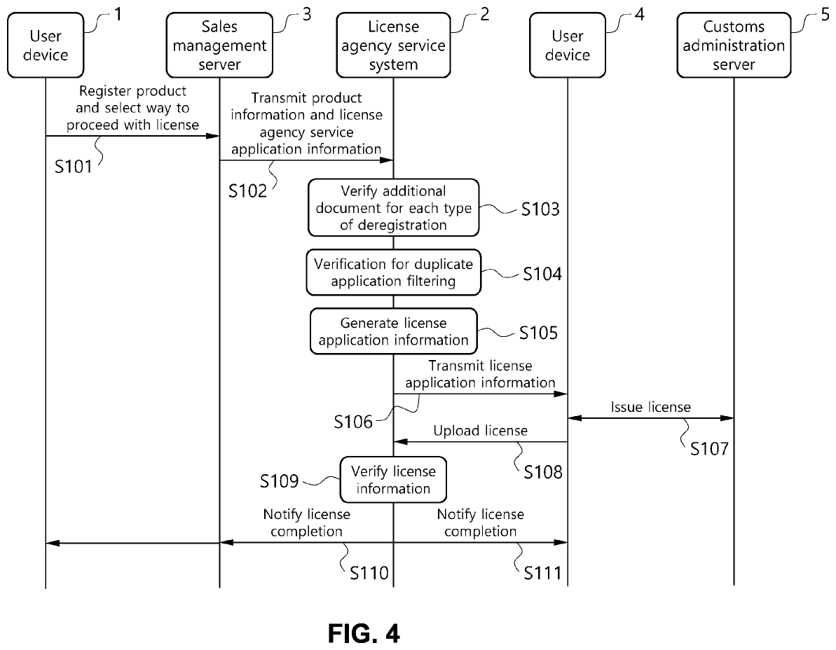

A license agency service method as described below with reference to FIGS. 4 to 6 may be performed by the license agency service system embodied in the form of the computing device including the hardware 200 described above with reference to FIG. 2. For example, the license agency service method may be provided to the user in the form of a service based on at least one of application, software or any other program that runs on the user device and/or the server.

In an embodiment, the processor 202 may execute the instructions stored in the memory 201 to receive the license agency service application information of the seller and the product information of one or more products that the seller will export from one or more devices related to the seller (for example, the user device of the seller or the sales management server).

Additionally, the processor 202 may generate the license application information based on the license agency service application information and the product information, and provide the same to the user device of one or more customs agents. When the customs agent receives the license information corresponding to the license application information from the customs administration server, the processor 202 may receive the license information from the user device of the customs agent or the customs administration server and provide the license information to one or more devices related to the seller.

FIG. 3 is a schematic block diagram showing the service module and the authentication module of the license agency service system according to an embodiment.

Referring to FIG. 3, the service module 21 of the license agency service system 2 according to an embodiment includes an application information verification unit 211 to verify whether all information needed to apply for a license on the behalf of the seller is furnished and/or whether license translation is required.

When making an export declaration, information needed to issue a license may be different depending on the type of product bound for export. For example, to export used vehicles, the used vehicles should be deregistered in the corresponding country, and in this instance, the required documents for license application are different depending on the type of deregistration, for example, export deregistration, scrappage deregistration, deregistration through car scrap takeover, etc. Accordingly, in an embodiment, the license agency service system 2 may request the seller to describe the deregistration type of product bound for export when the seller applies for the license agency service, pre-store required information items in the application information verification unit 211 for each deregistration type, and verify whether all the required information items for export declaration according to the deregistration type described by the seller was received.

However, this is provided by way of illustration, and the deregistration type information is usually required when the product bound for export is a used vehicle, and the deregistration type information may not be required depending on the type of product bound for export.

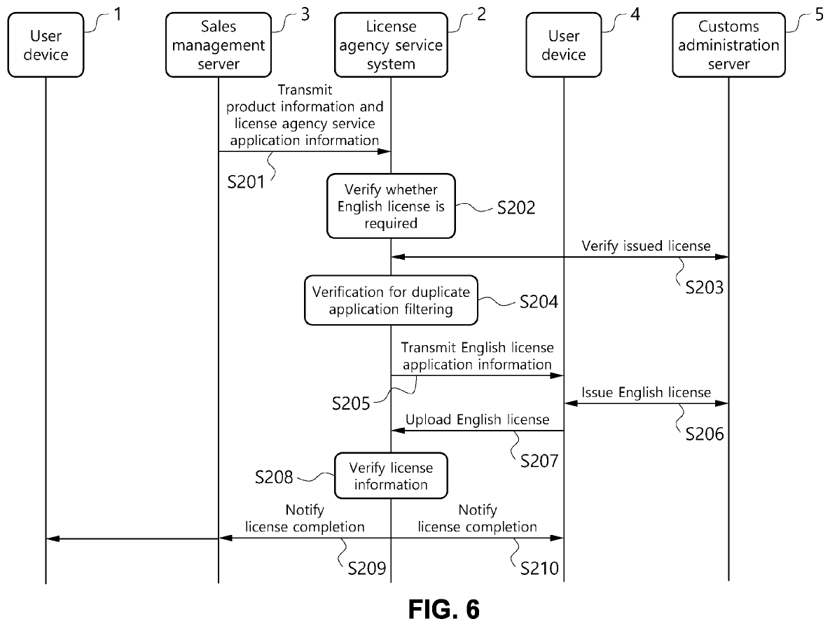

Alternatively, a translated license in a specific language (for example, an English export permit) may be required for customs clearance in an importing country (i.e., the country of the buyer who purchased the corresponding product) according to the customs clearance requirements of the importing country. In preparation for this, in an embodiment, the license agency service system 2 may request the seller to describe country information to export when the seller applies for the license agency service, or may receive country information corresponding to the nationality of the buyer from the sales management server. Additionally, the application information verification unit 211 may pre-store information associated with one or more countries that require an English license, and verify whether a translated license is required in relation to the license agency service for which the seller applied. The translated license issuance process will be described in detail with reference to FIG. 6.

In an embodiment, the service module 21 of the license agency service system 2 includes a duplicate check unit 212. The duplicate check unit 212 plays a role in verifying whether license issuance for the corresponding product is already being performed through a request from the same seller or another user, based on the license agency service application information and/or the product information received from the user device of the seller and/or the sales management server.

For example, the license agency service application information transmitted from the seller and/or the sales management server to the license agency service system 2 may include information such as declarant, export agent, buyer, declaration type, payment method, country of destination, port of loading, transport company (for example, shipping company or air freight company), transport means (for example, vessel name or flight number), estimated time of departure, bonded warehouse in which cargo is (will be) loaded, etc. Additionally, the product information transmitted from the seller and/or the sales management server to the license agency service system 2 may include the condition of the product, product name, brand name, model/size, description, quantity, unit price, cost and product identifier (for example, in the case of used vehicle, vehicle identification number), etc.

The duplicate check unit 212 may transmit identification information corresponding to all or some of the information items of the license agency service application information and/or the product information to the license management module 22 to allow the license management module 22 to verify whether the export license application for the same product is already underway. When it is determined that the license declaration to be made on behalf of the seller is already underway, the duplicate check unit 212 may reject the licensing agency service of the seller.

In an embodiment, the license management module 22 of the license agency service system 2 includes an information extraction unit 221. The information extraction unit 221 plays a role in extracting the required information items for license application of the corresponding product from the license agency service application information and/or the product information received at the service module 21 to generate the license application information that will be provided to the customs agent.

For example, in the export of the product, the required information for license application may be different depending on shipment type (for example, a container ship or a Ro-Ro ship, etc.) of the corresponding product. The information extraction unit 221 may selectively gather one or more required information items for license application according to the corresponding shipment type from the information received at the service module 21 to generate the license application information that will be transmitted to the customs agent.

This operation may be performed in a way that the customs agent connects to the license agency service system 2 to select a necessary document and download the document, or the information extraction unit 221 automatically generates a data packet containing the required information or documents for the corresponding license application, and provides the corresponding data packet to the user device of the customs agent through an e-mail or another form of user interface.

In an embodiment, the license management module 22 includes a license verification unit 222. When the license information issued from the customs agent is uploaded onto the license agency service system 2 or the license agency service system 2 receives the license information from the customs administration server, the license verification unit 222 may verify whether the information items of the license information are consistent with the license agency service application requested from the seller. For example, the license verification unit 222 may verify whether preset specific information items such as shipment type, product name, seller name, etc. in the information items recorded on the export permit are consistent with the license agency service application information of the seller. However, the number and type of information items for verification is not limited to the above-described example.

FIG. 4 is a flowchart showing each step of the license agency service method according to an embodiment.

Referring to FIG. 4, the seller who exports the product, for example, a used vehicle, to the foreign country may register the product in the sales management server 3 using the user device 1, and select the way to proceed with an export license (S101). In this instance, selecting the way to proceed with a license refers to, for example, selecting whether to apply for the license agency service through the license agency service system 2 or get a license by the direct contact with a customs agent.

When the seller applies for the license agency service through the license agency service system 2, the sales management server 3 may transmit the license agency service application information and the product information corresponding to the seller and the product bound for export to the license agency service system 2 (S102).

For example, the sales management server 3 may transmit, to the license agency service system 2, (i) personal information of the seller, buyer and/or export agent (company name/name, address, representative, business registration number, etc.), (ii) shipping terms information such as the country of destination, port of loading, transport company (for example, shipping company or air freight company), transport means (for example, vessel name or flight number), shipment type, estimated time of departure, bonded warehouse in which cargo is (will be) loaded, etc., (iii) product information such as the product name, brand name, model/size, description, quantity, product identifier (for example, in the case of used vehicle, vehicle identification number), the condition of the product, etc., (iv) transaction terms information such as the payment method, unit price, cost, etc. based on the information transmitted from the seller for product sales through the sales management server 3.

In an embodiment, part of the information transmitted from the sales management server 3 to the license agency service system 2 may be information automatically generated in the product trade through the sales management server 3 without the seller's input. For example, when the overseas buyer purchases the used vehicle of the seller registered in the sales management server 3, the sales management server 3 may automatically determine the country of destination and/or the port of loading to which the corresponding used vehicle will be exported based on the user information of the buyer registered in the sales management server 3, and transmit the same to the license agency service system 2 as the part of the license agency service application information.

The information needed for the license agency service of the license agency service system 2 may be different for each type of product bound for export, and in this instance, the type of product may represent what type of product is the corresponding product and/or status of registration of the corresponding product in the exporting country.

For example, in the Republic of Korea, to export used vehicles, the corresponding vehicles should be deregistered in the corresponding country. In this instance, the required documents for export declaration may be different depending on the type of deregistration, for example, export deregistration, scrappage deregistration or deregistration through the certificate of car scrap takeover, etc. In the case of export deregistration, any document is not required, but in the case of scrappage deregistration and deregistration by the certificate of car scrap takeover, a bill of scrap business is required, and further, in the case of deregistration by the certificate of car scrap takeover, a register is further required for export declaration.

Accordingly, to furnish proper documents for each type of deregistration of the product bound for export, in an embodiment, the license agency service system 2 may be further configured to receive information associated with the type of deregistration of the product bound for export from the sales management server 3, and verify whether all the required information for export declaration was received at the license agency service system 2 based on the preset information items for each type of deregistration (S103). As a result of verification, when an additional information item is needed according to the type of deregistration, the license agency service system 2 may provide an error occurrence notification to the seller and/or the sales management server 3 to request the corresponding document.

Additionally, in an embodiment, the license agency service system 2 may verify whether the license agency service application requested through the seller or the sales management server 3 is already being handled (S104). To this end, when the license agency service system 2 receives the license agency service application, the license agency service system 2 may generate and store the identification information corresponding to all or some of the information items of the received license agency service application information and/or the product information, and manage the status of the license based on the identification information. For example, in the case of used vehicle, a fixed and unique vehicle identification number of each vehicle or a product code of the used vehicle assigned by the sales management server 3 may be used as the identification information, but is not limited thereto.

In this embodiment, the license agency service system 2 may check whether licensing for the same product overlaps based on the identification information of the product (S104), and when non-overlapping application is determined, may proceed with the license application procedure, and when duplication application is found, provide an error occurrence notification to the seller and/or the sales management server 3.

In the license agency service application where the required documents for export declaration for each deregistration type are all received and non-overlapping application is determined, the license agency service system 2 may extract the required information items for export declaration of the corresponding product based on the information received from the seller and/or the sales management server 3 to generate the license application information (S105). The generated license application information may be provided to the user device 4 of the customs agent that will make an export declaration on behalf of the seller.

In an embodiment, the license application information may be automatically generated by the license agency service system 2 in the form of a data packet containing the required information and documents for export declaration. However, this is provided by way of illustration, and in another embodiment, the license agency service system 2 may provide a user interface to allow the customs agent to connect to the license agency service system 2 to select and download necessary information or documents, and selectively providing the information or document through the user interface may correspond to transmitting the license application information of the present disclosure.

In an embodiment, the required information or documents for export declaration of the product may be different depending on the shipping terms or transaction terms (for example, shipment type) of the corresponding product. For example, when exporting used vehicles using a container ship, a car deregistration certificate, an invoice, a shoring image for securing cargo in the container and a shoring statement are required for export declaration, but in the case of a Ro-Ro ship that does not need shoring, only the car deregistration certificate and the invoice may be used to make an export declaration. In this instance, the invoice refers to a commercial invoice containing the consignor, consignee, shipment type, country of destination, etc.

Accordingly, in this embodiment, the license agency service system 2 may identify the shipping terms or transaction terms (for example, shipment type) of the corresponding product through the license agency service application information received from the seller, and gather the preset information items according to the identified requirements to generate the license application information that will be provided to the customs agent.

In an embodiment, the customs agent that will apply for a license on behalf of the seller may be appointed by the seller or automatically determined by the license agency service system 2. When the license agency service system 2 automatically determines the customs agent to which the license application information will be transmitted, the license agency service system 2 may store the details of export declaration accomplished by each customs agent, and determine a customs agent with a wealth of experience in export declaration having the same attributes based on the attributes (for example, shipping terms such as the country of destination, shipment type, etc.) of the details of export declaration requested from the seller as the customs agent that matches the corresponding export declaration to perform the license procedure.

In an embodiment, the license agency service system 2 may determine the customs agent that matches the export declaration or will be recommended to the seller based on the membership level of one or more customs agents affiliated with the license agency service system 2. For example, the license agency service system 2 may store the membership level information of the affiliate customs agents, differently give recommendation scores for each membership level of the customs agents and provide a list of recommended customs agents to the seller, and the higher the membership level of the customs agent, the greater the chance to be selected, leading to business activities through the license agency service system 2.

In this instance, the membership level of the customs agents affiliated with the license agency service system 2 may be determined by a variety of criteria, for example, the number of licenses issued for each customs agent through the license agency service system 2, evaluation of the customs agents by other users, or payments made by the customs agents and given to the license agency service system 2, etc., and is not limited to a particular method.

In another embodiment, when the license agency service application information is received at the license agency service system 2 from the sales management server 3, the license agency service system 2 may determine the customs agent that will proceed with the corresponding export declaration based on the membership level of the seller managed in the sales management server 3. To this end, the sales management server 3 may transmit the membership level of the seller together when transmitting the license agency service application information and the product information to the license agency service system 2. In this instance, the license agency service system 2 may differently determine the customs agent that will make an export declaration on behalf of the seller for each membership level of the seller, based on the membership level of the seller in the trade service offered by the sales management server 3.

The customs agent may receive the license application information from the license agency service system 2 using the user device 4 (S106), and make an export declaration to the customs agency such as the customs administration server 5 using the received license application information to obtain a license (S107). Subsequently, the license agency service system 2 may receive the issued license, i.e., an export permit (S108).

The embodiments shown in the drawings describe that the license is uploaded onto the license agency service system 2 from the user device 4 of the customs agent. However, this is provided by way of illustration, and in another embodiment, the license agency service system 2 may receive the license issued through task completion accomplished by the customs agent directly from the customs administration server 5, or through another service server (not shown) that relays information of the customs administration server 5. In the present disclosure, receiving, by the license agency service system 2, the information from the customs administration server 5 is intended to include receiving the information of the customs administration server 5 through a third server.

For example, the Korean customs administration provides an Application Programming Interface (API) for searching customs clearance related information through the Internet customs clearance portal (UNI-PASS). In this instance, when a license is issued through task completion accomplished by the customs agent, the license agency service system 2 may search the information of the customs administration server 5 and receive the license through the Internet customs clearance portal (UNI-PASS) API.

Alternatively, the license agency service system 2 may receive the license from the customs administration server 5 through a service server (not shown) that relays the information of the customs administration server 5. In this instance, the service server may be, for example, a server related to an API solution service that provides information collection API of specific fields, or a server related to customs clearance agency service solution that the customs agent uses to handle his/her tasks, and is not limited to a particular purpose or method.

In an embodiment, the license agency service system 2 may verify whether the license information received from the customs agent is consistent with the details of the license agency service application of the seller (S109). For example, the license agency service system 2 may verify whether one or more information items of the license information, for example, shipment type, product name and/or seller name, are consistent with the license agency service application information sent from the seller, but the type of information item for verification is not limited thereto.

As a result of verifying the license information, when the license information is consistent with the details of the license agency service requested from the seller, the license agency service system 2 may transmit a notification of completion of the export declaration and license issuance procedure to the seller (S110). That is, the license agency service system 2 may directly transmit the license completion notification to the user device 1 of the seller, or transmit the license completion notification to the sales management server 3 that has traded in the seller's product to allow the seller to be informed of the same from the sales management server 3 (S110). Additionally, in an embodiment, the license agency service system 2 may be further configured to transmit the license completion notification to the user device 4 of the customs agent that acts for the corresponding license on behalf of the seller (S111).

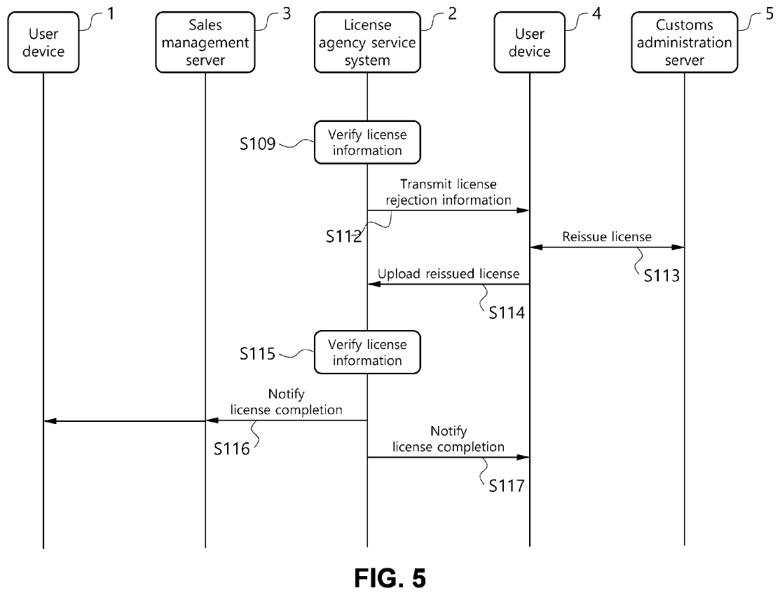

In contrast, when the verification of the license information fails due to inconsistency of any information item of the issued license with the details of the license agency service application of the seller (S109), the license agency service system 2 may transmit license rejection information to the user device 4 of the customs agent as shown in FIG. 5 (S112).

The customs agent having received the license rejection information may identify the information item that is inconsistent with the license agency service application information through the license rejection information, and correct it and apply for license reissue to the customs management authority such as the customs administration server 5 (S113).

When the license information is reissued, likewise, the license agency service system 2 may receive the reissued license from the user device 4 of the customs agent or the customs administration server 5 (including receiving via another server) (S114). The license agency service system 2 may verify the reissued license information by the same method as the previous method (S115), and when the verification succeeds, transmit a license completion notification to the seller and/or the customs agent to notify that the export declaration and license issuance is completed (S116, S117).

In an embodiment, the license agency service system 2 may automatically generate charge information for charging the fee of the customs agent to the seller for the export declaration agency service based on the license agency service application information and the product information received from the seller and the license information received from the customs agent, and transmit the same to one or more devices related to the seller (the user device and/or the sales management server).

For example, an amount of money corresponding to the service fee of the customs agent in the charge information may be determined based on the quantity, unit price and cost of the product for which the export declaration is made, whether the license is reissued in the license application process, how many times the license is reissued, preset rate information for each of customs agent, etc. The license agency service system 2 may extract the information items necessary to calculate the charge from the license application information provided to the customs agent through the license agency service system 2 and the license information uploaded from the customs agent and generate the charge information including a license fee determined based on the same, so that the information transmitted and received through the license agency service system 2 may be used as basic data for charging the fee of the customs agent to the seller.

Additionally, in an embodiment, the license agency service system 2 may proceed with payment between the license agency service system 2 and the sales management server 3 to make sure that the payment process between the seller and the customs agent is performed in the product sales and payment process through the sales management server 3. When the seller sold a used vehicle through the sales management server 3, the overseas buyer may make a payment to the administrator of the sales management server 3 through a payment interface of the sales management server 3, and the sales management server 3 may give the amount of money paid by the buyer minus the management fee of the sales management server 3 to the seller. In this instance, the license agency service system 2 may transmit the charge information of the license fee incurred in the export declaration of the product (including the charge of the customs agent and/or the management fee of the license agency service system 2) to the sales management server 3, to allow the sales management server 3 to give the amount of sales minus the license fee to the seller.

In this instance, the service module 21 of the license agency service system 2 may be further configured to perform an electronic payment process of receiving the amount of money corresponding to the license fee from the sales management server 3 into the administrator's account of the license agency service system 2, and giving the amount of money corresponding to the charge of the customs agent in the license fee to one or more customs agents. Alternatively, the service module 21 may only transmit the charge information for paying the charge of the customs agent (including payment means information such as the account number of the customs agent, etc.) to the sales management server 3 to allow the sales management server 3 to directly give the license fee in the amount of sales of the used vehicle to each customs agent.

FIG. 6 is a flowchart showing each step of the license agency service method according to another embodiment.

Depending on exporting countries, even though an export declaration and a license were granted through the customs management authority of the exporting country, a translated license (for example, an English license) may be required for customs clearance in the importing country. In preparation for this, in an embodiment, the license agency service system 2 may perform an operation necessary for license translation by verifying whether the translated license is required based on the country information of the country of destination in the export declaration.

In the following embodiment, the translated license is described as an English license. However, the type of translated license is not limited thereto, and language into which the license is to be translated may be different depending on the type of license required for customs clearance in the importing country.

Referring to FIG. 6, in this embodiment, the license agency service system 2 may receive the license agency service application information and the product information (S201), and verify to determine whether an English license is required based on the country information of the country of destination in the received information (S202). To this end, the license agency service system 2 may store a list of countries that requires an English license for customs clearance, and determine whether an English license is required depending on whether the country of destination of the license agency service application information is included in the list.

Although the embodiment shown in FIG. 6 shows that the license agency service application information and the product information is received at the license agency service system 2 from the sales management server 3, this is provided by way of illustration, and in another embodiment, the license agency service system 2 may directly receive the license agency service application information and/or the product information from the seller via communication with the user device 1 of the seller.

When it is determined that an English license is required, the license agency service system 2 may verify whether there is an issued license for the corresponding license agency service application and the product (S203).

In this instance, verifying the presence or absence of an issued license is to determine whether there is an original license (i.e., a Korean license) that is equivalent to an English license. In the Republic of Korea, in the customs clearance procedure of the customs administration, an English license is issued by translating the existing license in the presence of the issued Korean license. Accordingly, in an embodiment, the license agency service system 2 may determine whether there is an original export license for the same product via communication with the customs management authority such as the customs administration server 5, and when there is no original license, may reject English license application or first proceed with a procedure for obtaining a Korean license.

Taking the Korean customs administration server 5 as an example, the license agency service system 2 may determine whether there is an original license by searching the information on the customs administration server 5 using the Internet customs clearance portal (UNI-PASS) API provided by the customs administration server 5. For example, when the product bound for export is a used vehicle, the license agency service system 2 may determine the presence or absence of an original license by determining whether there is an export permit number using the vehicle identification number of the corresponding used vehicle through the customs administration API.

Additionally, the license agency service system 2 may verify whether English license application is a duplication of previous application (S204). In this instance, the verification of whether the application is a duplicate application refers to a process of verifying whether the English license application is a duplicate of a previous application, not the original license application procedure. The verification procedure itself is the same as the Korean license verification process, and to avoid redundancy, the detailed description is omitted.

When the verification of the English license agency service application succeeds, the license agency service system 2 may transmit English license application information required for English license issuance to the user device 4 of the customs agent (S205), and the customs agent may receive an English license issued by performing the declaration procedure of the customs management authority such as the customs administration server 5 (S206, S207). In the same way as the foregoing description related to the Korean license acquisition process (S108, S114), although FIG. 6 shows that the license agency service system 2 receives the English license from the user device 4 of the customs agent, in another embodiment, the license agency service system 2 may receive the English license from the customs administration server 5 (including receiving via another server), not the user device 4 of the customs agent.

In an embodiment, in the same way as the Korean license verification process, the license agency service system 2 may verify whether the English license information is consistent with the license application information of the seller based on one or more information items of the issued English license information (S208). When the verification succeeds, the license agency service system 2 may transmit a license completion notification to the seller and/or the customs agent to notify that the English license issuance was completed (S209, S210).

The export license agency service method according to embodiments as described hereinabove may be, at least in part, implemented as a computer program and recorded in a computer-readable recording medium. The computer-readable recording medium that records a program for implementing the operation by the method according to embodiments includes any type of recording device in which computer-readable data is stored. Examples of the computer-readable recording medium include ROM, RAM, CD-ROM, magnetic tape, floppy disk, optical data storage devices. Additionally, the computer-readable recording medium is distributed over computer systems connected via a network, and may store and execute the computer-readable code in a distributed manner. Additionally, a functional program, code and a code segment for realizing this embodiment will be easily understood by persons having ordinary skill in the technical field to which this embodiment belongs.

Although the present disclosure has been hereinabove described with reference to the embodiments shown in the drawings, this is provided by way of illustration and those skilled in the art will understand that a variety of modifications and variations may be made thereto. However, it should be understood that such modifications fall within the scope of technological protection of the present disclosure.

What is claimed is:

1. A license agency service system comprising:
a service module configured to receive license agency service application information of a seller and product information of one or more products that the seller will export from one or more devices related to the seller; and
a license management module configured to transmit license application information generated based on the license agency service application information and the product information to a user device of one or more agents, and receive license information issued from a customs management authority, corresponding to the license application information, from the agent or the customs management authority,
wherein the service module is further configured to provide the license information to the one or more devices.

2. The license agency service system according to claim 1, wherein the service module is further configured to connect to a sales management server for trade in the one or more products to receive at least one of the license agency service application information or the product information from the sales management server via communication.

3. The license agency service system according to claim 1, wherein the license agency service application information includes deregistration type information of the product, and wherein the service module includes an application information verification unit further configured to verify the license agency service application information based on a preset required information item corresponding to the deregistration type information.

4. The license agency service system according to claim 1, wherein the license agency service application information includes country information to which the product is to be exported,
wherein the service module includes an application information verification unit configured to determine whether license translation is required based on the country information, and transmit translated license application information to the license management module in response to the determination that the license translation is required, and
wherein the license management module is further configured to, in response to the translated license application information being received, transmit the translated license application information to the agent and receive translated license information from the agent or the customs management authority.

5. The license agency service system according to claim 1, wherein the service module includes a duplicate check unit configured to transmit identification information corresponding to the license agency service application information or the product information to the license management module and verify whether license issuance for the product information is a duplicate application.

6. The license agency service system according to claim 1, wherein the license agency service application information includes shipment type information for the export of the product, and
wherein the license management module includes an information extraction unit configured to selectively gather the information received at the service module based on the shipment type information to generate the license application information.

7. The license agency service system according to claim 1, wherein the license management module includes a license verification unit configured to verify whether at least one of a shipment type, a product name or a name of the seller of the license information received from the agent or the customs management authority is consistent with the license application information.

8. A license agency service method comprising:
receiving, by a license agency service system, license agency service application information of a seller and product information of one or more products that the seller will export from one or more devices related to the seller;
transmitting, by the license agency service system, license application information generated based on the license agency service application information and the product information to a user device of one or more agents;
receiving, by the license agency service system, license information issued from a customs management authority, corresponding to the license application information, from the agent or the customs management authority; and
providing, by the license agency service system, the license information to the one or more devices.

9. The license agency service method according to claim 8, wherein the license agency service application information includes deregistration type information of the product, and
wherein the method further comprises:
before the transmitting to the user device of the agent,
verifying, by the license agency service system, the license agency service application information based on a preset required information item corresponding to the deregistration type information.

10. The license agency service method according to claim 8, wherein the license agency service application information includes country information to which the product is to be exported, and
wherein the method further comprises:
determining, by the license agency service system, whether to apply for a translated license based on the country information;
transmitting, by the license agency service system, translated license application information based on the license information issued corresponding to the product to the agent in response to the determination that license translation is required; and
receiving, by the license agency service system, translated license information from the agent or the customs management authority.

11. The license agency service method according to claim 8, further comprising:
before the transmitting to the user device of the agent,
verifying, by the license agency service system, whether license issuance for the product information is a duplicate application using identification information corresponding to the license agency service application information or the product information.

12. The license agency service method according to claim 8, wherein the license agency service application information includes shipment type information for the export of the product, and
wherein the transmitting to the user device of the agent comprises selectively gathering, by the license agency service system, the information received at the license agency service system based on the shipment type information to generate the license application information.

13. The license agency service method according to claim 8, further comprising:
before the providing of the license information to the one or more devices,
verifying, by the license agency service system, whether at least one of a shipment type, a product name or a name of the seller of the license information received from the agent or the customs management authority is consistent with the license application information.

14. A computer program stored in a computer-readable recording medium to perform the license agency service method according to claim 8.

15. A computing device comprising:
a memory in which executable instructions are stored;
a communication module configured to communicate with an external system; and
a processor connected to the memory and the communication module to enable communication therebetween,
wherein the processor is configured to execute the instructions to:
receive license agency service application information of a seller and product information of one or more products that the seller will export from one or more devices related to the seller,
transmit license application information generated based on the license agency service application information and the product information to a user device of one or more agents,
receive license information issued from a customs management authority, corresponding to the license application information, from the agent or the customs management authority, and
provide the license information to the one or more devices.
